(19) United States
(12) Patent Application Publication
(10) Pub. No.: US 2023/0342171 A1
(43) Pub. Date: Oct. 26, 2023

(54) PRIVACY-PRESERVING MACHINE-LEARNING FOR CAPACITY FORECASTING IN A HYPER-CONVERGED SOFTWARE-DEFINED STORAGE PLATFORM

(71) Applicant: VMware, Inc., Palo Alto, CA (US)

(72) Inventors: Yang YANG, Shanghai (CN); Hexin ZHANG, Shanghai (CN); Layne Lin PENG, Shanghai (CN); Jiahao CHEN, Guangdong (CN); Chengmao LU, Shanghai (CN); Sixuan YANG, Shanghai (CN)

(73) Assignee: VMware, Inc., Palo Alto, CA (US)

(21) Appl. No.: 17/725,572

(22) Filed: Apr. 21, 2022

(51) Int. Cl. G06F 9/455

(52) U.S. Cl. CPC G06F 9/45558; G06F 2009/45583

(57) ABSTRACT

Capacity forecasting may be performed for distributed storage resources in a virtualized computing environment. Historical data indicative of usage of the storage resources is transformed into a privacy-preserving format and is preprocessed to remove outliers, to fill in missing values, and to perform normalization. The preprocessed historical data is inputted into a machine-learning model, which applies a piecewise regression to the historical data to generate a prediction output.

### BACKGROUND

Unless otherwise indicated herein, the approaches described in this section are not admitted to be prior art by inclusion in this section.

Virtualization allows the abstraction and pooling of hardware resources to support virtual machines in a software-defined networking (SDN) environment, such as a software-defined data center (SDDC). For example, through server virtualization, virtualized computing instances such as virtual machines (VMs) running different operating systems (OSs) may be supported by the same physical machine (e.g., referred to as a host). Each virtual machine is generally provisioned with virtual resources to run an operating system and applications. The virtual resources may include central processing unit (CPU) resources, memory resources, storage resources, network resources, etc.

A software-defined approach may be used to create shared storage for VMs and/or for some other types of entities, thereby providing a distributed storage system in a virtualized computing environment. Such software-defined approach virtualizes the local physical storage resources of each of the hosts and turns the storage resources into pools of storage that can be divided and accessed/used by VMs or other types of entities and their applications. The distributed storage system typically involves an arrangement of virtual storage nodes that communicate data with each other and with other devices. One type of virtualized computing environment that uses a distributed storage system is a hyper-converged infrastructure (HCI) environment, which combines elements of a traditional data center: storage, compute, networking, and management functionality.

Managing growth for a storage system can be difficult. When a storage system exhausts the available storage, such decrease in storage capability causes performance degradation and is also a budgeting challenge for the entities that provide or use storage resources. Some techniques may use intelligent capacity forecasting techniques (e.g., auto-scaling of storage resources) so as to address storage needs in advance. However, such intelligent capacity forecasting techniques typically employ some type of threshold value control mechanism in order to perform capacity forecasting (e.g., allocate A new additional storage capacity when a threshold amount B of existing storage capacity has been consumed).

Such threshold value control mechanisms do not work efficiently for distributed storage systems and/or other types of storage systems, due to several reasons. For example, some users (e.g., consumers or customers of storage resources) need time to order/enlarge their storage capacity, for instance a timeframe of about 21 days or more. If the existing storage capacity is being consumed too quickly, then the allocation of additional storage capacity will need to be performed and completed in a much shorter timeframe, which is not a user-friendly experience/process.

On the other hand, if existing storage capacity is being consumed slowly, enlarging the storage capacity after a threshold is met may cause unnecessary resource allocation and cost. This is thus a wasteful result.

Historical data (e.g., data indictive of consumers' use of storage capacity) is sometimes analyzed by capacity forecasting techniques to assist in providing more accurate forecasts. However, for security/privacy reasons, a large number of customers often refuse to provide their historical data for analysis. This refusal serves as an obstacle for storage capacity prediction. Moreover, historical data that spans a relatively short timeframe is generally insufficient for capacity forecasting.

### BRIEF DESCRIPTION OF DRAWINGS

FIG. 1A is a schematic diagram of a computing architecture that that can implement capacity forecasting;

FIG. 1B is a schematic diagram illustrating an example virtualized computing environment that can be implemented in the computing architecture of FIG. 1A;

FIG. 2 is a flowchart of an example capacity forecasting (planning) method that may be implemented in the architecture/environment of FIGS. 1A and 1B;

FIG. 3 is a flowchart showing a workflow of an example privacy-preserving framework for the capacity forecasting method of FIG. 2; and

FIG. 4 shows an example regression approach for the capacity forecasting method of FIG. 2.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. The aspects of the present disclosure, as generally described herein, and illustrated in the drawings, can be arranged, substituted, combined, and designed in a wide variety of different configurations, all of which are explicitly contemplated herein.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, such feature, structure, or characteristic may be implemented in connection with other embodiments whether or not explicitly described.

The present disclosure addresses various drawbacks associated with capacity forecasting for resources (such as storage) in a virtualized computing environment. For example, methods, systems, and devices are disclosed herein that use a multivariate and privacy-preserving piecewise regression model and algorithm to perform storage capacity forecasting for a hyper-converged, software-defined storage platform (such as a distributed storage system).

The privacy-preserving aspect of the disclosed embodiments of the capacity forecasting algorithm may involve using encrypted historical data for machine-learning, thereby relieving the privacy concerns of users (e.g., customers or other consumers that may be reluctant to provide their historical data for use in capacity forecasting). The disclosed embodiments also perform checking of conditions and preprocessing of the historical data, thereby improving the reliability of the results of the capacity forecasting algorithm.

Computing Environment

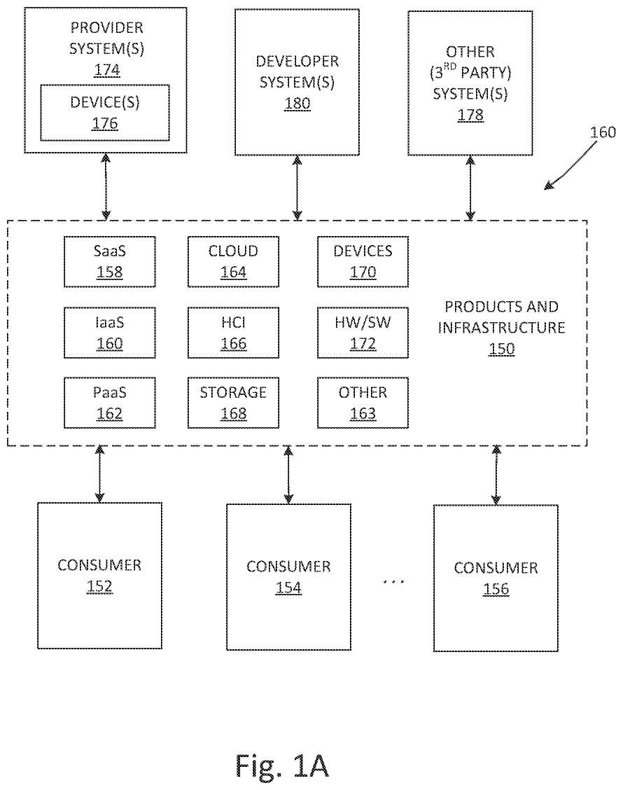

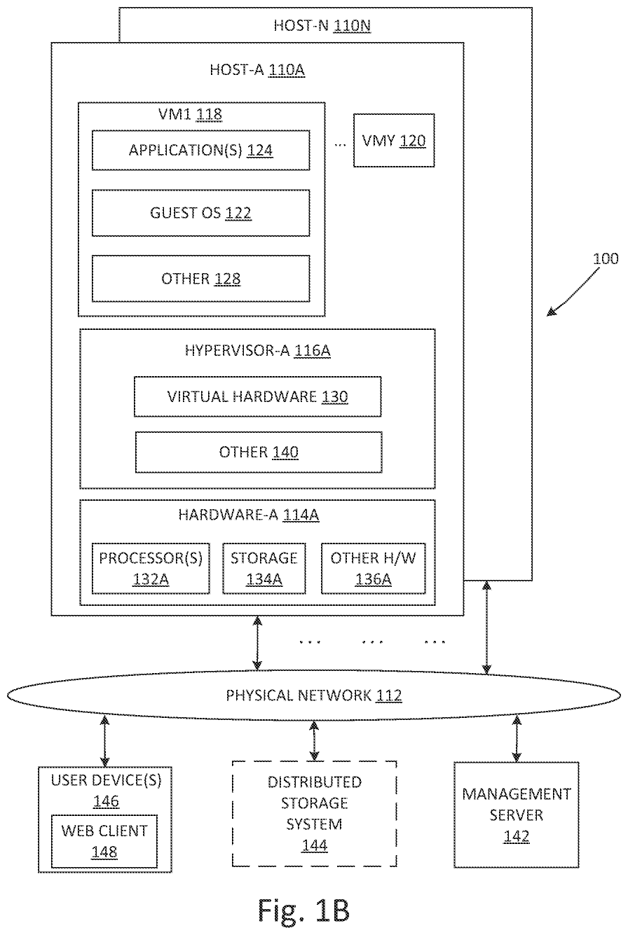

Referring first to the schematic diagram of FIG. 1A, shown generally at 160 is a computing architecture that that can implement capacity forecasting. The computing architecture 160 includes/provides products and infrastructure 150. Such products and infrastructure 150 (depicted as a box with broken lines in FIG. 1A so as symbolically represent that such products/infrastructure can be discrete, integrated together with each other, self-contained, distributed, singular or multiple, virtualized or non-virtualized, and so forth) may include various services, systems, networks and devices, etc. that may be provided by one or more providers for consumption by users (e.g., consumers 152-156 such as customers of the providers).

For example, the providers may deliver various services to the consumers 152-156 through a network (such as the Internet). Such services may include software as a service (SaaS) 158, infrastructure as a service (IaaS) 160, platform as a service (PaaS) 162, and/or other services/products 163. As other examples, the products and infrastructure 150 may provide a public or private cloud 164 or other type of public/private network, and related services.

Still further, the products and infrastructure 150 may provide a hyper-converged infrastructure (HCI) 166, which may include or operate in conjunction with a software-defined storage platform 168. The storage platform 168 may be comprised of virtual storage nodes or other form of storage capacity, for which capacity forecasting may be performed accordance with various embodiments disclosed herein. Other virtual or non-virtual storage capacity may be provided by the products and infrastructure 150, for which capacity forecasting may also be performed.

The backend of the computing architecture 160 (e.g., within the products and infrastructure 150) that supports the delivery/allocation of the services 158-162, HCI 166, storage platform 168, etc. to the consumers 152-156 may be comprised of computing devices 170, storage units (including databases), hardware and software 172, virtual and physical components, etc. The consumers 152-156 may comprise end users, customers, system administrators, or other entities that access and consume/use the products and infrastructure 150 via user devices (such as mobile or desktop computing devices having browsers) at the front end of the computing architecture 160.

A provider system 174, associated with a provider or provider entity, may manage or operate the products and infrastructure 150. For example, the provider system 174 may develop and push/deliver/provide services (including capacity forecasting, storage capacity allocation, etc.) to support the use of the products and infrastructure 150 by the consumers 152-156, may provide and maintain the computing devices 170 and related hardware and software 172, may integrate hardware/software products and tools from other entities (such as a third party system 178) into the products and infrastructure 150, etc.

The provider system(s) 174 may include one or more computing devices 176 to manage the provisioning and maintaining of products (such as storage) that are provided to consumers 152-156. For instance, the computing devices 176 may perform the capacity forecasting algorithms and related operations described herein, including running an analytics portal (having a machine-learning model) that receives historical data and outputs forecasting results based on the historical data. The computing devices 176 may reside outside of the products and infrastructure 150, may reside within the products and infrastructure 150 (e.g., at the backend amongst the computing devices 170, such as at the cloud 164), and/or may reside elsewhere. The provider system(s) 174 may also operate in conjunction with a developer system 180 to develop products and updates for consumption by the consumers 152-156 or to otherwise support the usage/management of the resources in the products and infrastructure 150.

FIG. 1B is a schematic diagram illustrating an example virtualized computing environment 100 that can be implemented in the computing architecture of FIG. 1A. For instance, components of the virtualized computing environment 100 may provide some of the above-described products and infrastructure 150 to enable the delivery of services 158-162, HCI 166, storage platform 168, etc. to the consumers 152-156. Depending on the desired implementation, the virtualized computing environment 100 may include additional and/or alternative components than that shown in FIG. 1B.

In the example in FIG. 1B, the virtualized computing environment 100 includes multiple hosts, such as host-A 110A . . . host-N 110N that may be inter-connected via a physical network 112, such as represented in FIG. 1B by interconnecting arrows between the physical network 112 and host-A 110A . . . host-N 110N. For simplicity of explanation, the various components and features of the hosts will be described hereinafter in the context of host-A 110A. Each of the other hosts can include substantially similar elements and features.

The host-A 110A includes suitable hardware-A 114A and virtualization software (e.g., hypervisor-A 116A) to support various virtual machines (VMs). For example, the host-A 110A supports VM1 118 . . . VMY 120, wherein Y (as well as N) is an integer greater than or equal to 1. In practice, the virtualized computing environment 100 may include any number of hosts (also known as “computing devices”, “host computers”, “host devices”, “physical servers”, “server systems”, “physical machines,” etc.), wherein each host may be supporting tens or hundreds of virtual machines. For the sake of simplicity, the details of only the single VM1 118 are shown and described herein.

VM1 118 may include a guest operating system (OS) 122 and one or more guest applications 124 (and their corresponding processes) that run on top of the guest operating system 122. VM1 118 may include still further other elements 128, such as a virtual disk, agents, engines, modules, and/or other elements usable in connection with operating VM1 118.

The hypervisor-A 116A may be a software layer or component that supports the execution of multiple virtualized computing instances. The hypervisor-A 116A may run on top of a host operating system (not shown) of the host-A 110A or may run directly on hardware-A 114A. The hypervisor-A 116A maintains a mapping between underlying hardware-A 114A and virtual resources (depicted as virtual hardware 130) allocated to VM1 118 and the other VMs.

The hypervisor-A 116A may include or may operate in cooperation with still further other elements 140 residing at the host-A 110A. Such other elements 140 may include drivers, agent(s), daemons, engines, virtual switches, and other types of modules/units/components that operate to support the functions of the host-A 110A and its VMs.

According to various embodiments, the other elements 128 and/or 140 may collect historical data, such as information pertaining to current and past storage capacity usage, remaining available storage capacity, etc.; encrypt such historical data; and then send the encrypted historical data to a capacity forecasting algorithm that is executed by the computing device(s) 176 of the provider at the backend. The other elements 128 and/or 140 may in turn receive forecasting results from the capacity forecasting algorithm, decrypt the results, and then send the decrypted results to a user (e.g., a consumer such as a system administrator) for review to determine whether additional storage capacity will need to be requested from the provider.

Hardware-A 114A includes suitable physical components, such as CPU(s) or processor(s) 132A; storage resources(s) 134A; and other hardware 136A such as memory (e.g., random access memory used by the processors 132A), physical network interface controllers (NICs) to provide network connection, storage controller(s) to access the storage resources(s) 134A, etc. Virtual resources (e.g., the virtual hardware 130) are allocated to each virtual machine to support a guest operating system (OS) and application(s) in the virtual machine, such as the guest OS 122 and the applications 124 in VM1 118. Corresponding to the hardware-A 114A, the virtual hardware 130 may include a virtual CPU, a virtual memory, a virtual disk, a virtual network interface controller (VNIC), etc.

Storage resource(s) 134A may be any suitable physical storage device that is locally housed in or directly attached to host-A 110A, such as hard disk drive (HDD), solid-state drive (SSD), solid-state hybrid drive (SSHD), peripheral component interconnect (PCI) based flash storage, serial advanced technology attachment (SATA) storage, serial attached small computer system interface (SAS) storage, integrated drive electronics (IDE) disks, universal serial bus (USB) storage, etc. The corresponding storage controller may be any suitable controller, such as redundant array of independent disks (RAID) controller (e.g., RAID 1 configuration), etc.

A distributed storage system 144 may be connected to each of the host-A 110A . . . host-N 110N that belong to the same cluster of hosts. For example, the physical network 112 may support physical and logical/virtual connections between the host-A 110A . . . host-N 110N, such that their respective local storage resources (such as the storage resource(s) 134A of the host-A 110A and the corresponding storage resource(s) of each of the other hosts) can be aggregated together to form a shared pool of storage in the distributed storage system 144 that is accessible to and shared by each of the host-A 110A . . . host-N 110N, and such that virtual machines supported by these hosts may access the pool of storage to store data. In this manner, the distributed storage system 144 is shown in broken lines in FIG. 1, so as to symbolically convey that the distributed storage system 144 is formed as a virtual/logical arrangement of the physical storage devices (e.g., the storage resource(s) 134A of host-A 110A) located in the host-A 110A . . . host-N 110N. However, in addition to these storage resources, the distributed storage system 144 may also include stand-alone storage devices that may not necessarily be a part of or located in any particular host. The distributed storage system 144 of FIG. 1B may form part of the storage platform 168 of FIG. 1A.

According to some implementations, two or more hosts may form a cluster of hosts that aggregate their respective storage resources to form the distributed storage system 144. The aggregated storage resources in the distributed storage system 144 may in turn be arranged as a plurality of virtual storage nodes including clusters of storage nodes. Other ways of clustering/arranging hosts and/or virtual storage nodes are possible in other implementations. The distributed storage system 144 of FIG. 1B may form part of the storage platform 168 of FIG. 1A.

A management server 142 (or other network device configured as a management entity) of one embodiment can take the form of a physical computer or with functionality to manage or otherwise control the operation of host-A 110A . . . host-N 110N. In some embodiments, the functionality of the management server 142 can be implemented in a virtual appliance, for example in the form of a single-purpose VM that may be run on one of the hosts in a cluster or on a host that is not in the cluster of hosts.

A user (e.g., associated with one of the consumers 152-156 of FIG. 1A) may operate a user device 146 to access, via the physical network 112, the functionality of VM1 118 . . . VMY 120 (including operating the applications 124 and related microservices), using a web client 148 (such as a browser-based application). The user device 146 can be in the form of a computer, including desktop computers and portable computers (such as laptops and smart phones). In some embodiments, the user device 146 and/or the management server 142 (alternatively or in addition to the other elements 128 or 140) may collect, encrypt, and send the historical data (regarding storage capacity) to the capacity forecasting algorithm at the backend, and then receive/process the forecasting results.

Capacity Forecasting Framework

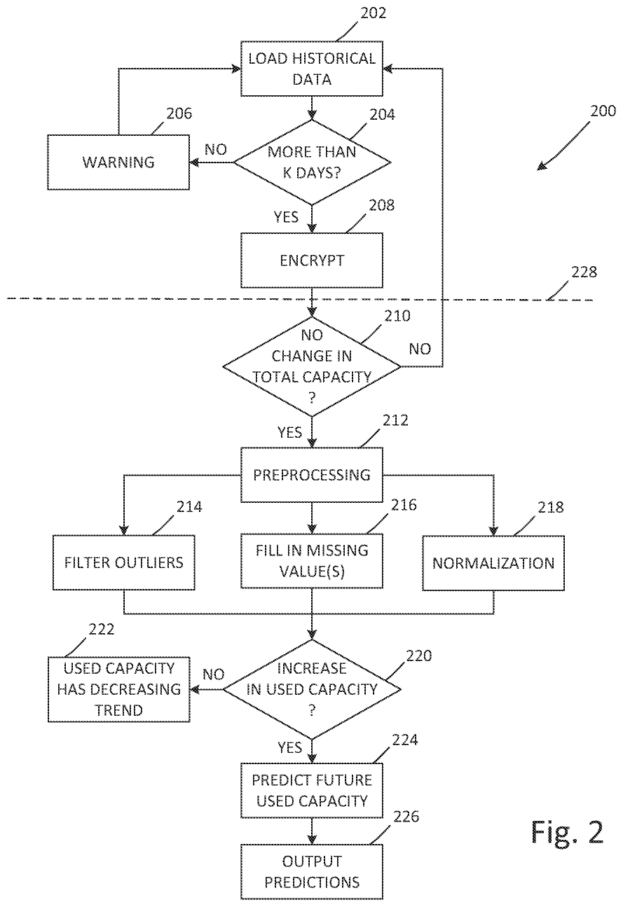

FIG. 2 is a flowchart of an example capacity forecasting (planning) method 200 that may be implemented in the architecture/environment of FIGS. 1A and 1B. For instance, the method 200 may include an algorithm having operations that may be implemented/performed by the computing device(s) 176 and/or 170 at the backend of the computing architecture 160 of FIG. 1B; by the other elements 128 and/or 140, user device(s) 146, and/or management server 142 of FIG. 1B at the front/back ends; and/or by other device(s).

The example method 200 may include one or more operations, functions, or actions illustrated by one or more blocks, such as blocks 202 to 226. The various blocks of the method 200 and/or of any other process(es) described herein may be combined into fewer blocks, divided into additional blocks, supplemented with further blocks, and/or eliminated based upon the desired implementation. In one embodiment, the operations of the method 200 and/or of any other process(es) described herein may be performed in a pipelined sequential manner. In other embodiments, some operations may be performed out-of-order, in parallel, etc.

The operations depicted above a dashed line 228 may be performed at a client side (e.g., at the front end at the user/consumer/customer side), while the operations depicted below the dashed line 228 may be performed at the provider side (e.g., at the back end). Other embodiments may shift or share operations between client and provider sides, in a manner that may differ than what is shown in the example of FIG. 2.

With respect to terminology used herein, the term physical capacity may refer to the raw storage capacity for a hyper-converged software-defined storage platform, such as the storage platform 168 of FIG. 1A or the distributed storage system 144 of FIG. 1B. The term total capacity may refer to an amount of the physical capacity that are allowed to be used by consumers 152-156. The term used capacity may refer to an amount of the total capacity that has already been consumed by the consumers 152-156.

The method 200 begins at a block 202 (“LOAD HISTORICAL DATA”), wherein a user's historical storage data is loaded, such as into a buffer, database, or other storage location where the historical data may be initially examined. The historical data may be collected by data collectors or other monitoring components for the user's storage system, for example. Examples of the historical data may include, but are not limited to, an amount of storage used at particular points of time (including time windows), an amount of unused/available storage at particular points of time, peaks and lows of storage usage over time (including time windows), identification of which storage nodes are being consumed and rates of consumption thereof, types and sizes of files and data being stored, history of capacity expansion, etc.

The block 202 may be followed by a block 204 (“MORE THAN K DAYS?”), wherein the historical data is examined to determine if the historical data spans at least K days of data or other threshold amount of historical data. K may be an integer, for example 50 days (about 1.5 months). Any value of K may be chosen so as to provide a data window with a sufficient amount of historical data, since too few of an amount of historical data may reduce prediction accuracy.

If the historical data spans less than K days (“NO” at the block 204), then a warning is issued at a block 206 (“WARNING”) so as to alert the user that the dataset has been rejected since an insufficient amount of training data (historical data) has been provided, and so a waiting period is entered and ensues, until K days are reached when a sufficient amount of historical data becomes available and is then loaded again at the block 202.

If, on the other hand, the loaded historical data spans more than K days (“YES” at the block 204), then the historical data is encrypted at a block 208 (“ENCRYPT”) or otherwise transformed into a privacy-preserving format. According to various embodiments, a machine-learning-based privacy-preserving framework may be used at the block 208 to encrypt the historical data, in a manner that the machine-learning process may operate on encrypted data. After the encryption at the block 208, the encrypted historical data is transferred to the backend side, for processing by the provider to forecast capacity.

Specifically, the backend receives the encrypted historical data, and then checks if the total capacity has changed, at a block 210 (“NO CHANGE IN TOTAL CAPACITY?”). If there is a change in total capacity (“NO at the block 210), in that the consumer has changed a usage pattern for the storage capacity so that more storage is available for consumption, then the method reverts back to the block 202 to wait to reach to K days since the change in total capacity and then to load the historical data. If, on the other hand, there is no change in total capacity (“YES” at the block 210), then the encrypted historical data is subject to preprocessing, at a block 212 (“PREPROCESSING”). The preprocessing may include one or more of filtering outliers at a block 214 (“FILTER OUTLIERS”), filling in missing values such as via interpolation at a block 216 (“FILTER MISSING VALUE(S)”), and performing normalization at a block 218 (“NORMALIZATION”). Some of the blocks 214-218 may be performed in sequence and/or in parallel in some embodiments, and may be performed so as to improve the accuracy of the capacity forecasting algorithm. Other types of preprocessing may be performed at the block 212, alternatively or in addition to blocks 214-218.

The preprocessing described above may be followed by a block 220 (“INCREASE IN USED CAPACITY?”), wherein before training a machine-learning model using the historical data, the method 200 checks the overall trend of the used capacity. For example, if the mean change in used capacity is below zero (“NO at the block 220), then this may indicate that the used storage capacity has a decreasing trend at a block 222 (“USED CAPACITY HAS DECREASING TREND”), thereby predicting/planning for further capacity may not be needed—the current rate/amount of storage capacity usage does not warrant increasing the total capacity.

However, if there is an increasing trend in used capacity (“YES” at the block 220), then this information indicates that an increase in total capacity may be needed. As such, the historical data is loaded into the capacity forecasting algorithm (machine-learning model), at a block 224 (“PREDICT FUTURE CAPACITY”) so as to predict future capacity. In some embodiments, the machine-learning model may be used to generate a prediction (e.g., a prediction output or a prediction result) of future capacity at the block 224 only if the usage indicates an increasing trend at the block 220, and otherwise does not perform a computation at the block 224 to provide the prediction.

The block 224 may be followed by a block 226 (“OUTPUT PREDICTIONS”), wherein the machine-learning model outputs the predictions for used capacity, usage rates, and/or provides other prediction output(s). According to various embodiments, the output provided at the block 226 is in the form of encrypted results. Such results may be in turn delivered back to the client side (users), so that the users can use their keys to decrypt the encrypted results.

With the foregoing description of the method 200 of FIG. 2, it can be seen that certain operations are performed before training (e.g., before the machine-learning operations at the block 224), as prerequisites to improving the accuracy of the predictions. The machine-learning-based privacy-preserving framework addresses consumers' privacy concerns, while the checking of conditions and preprocessing of data provide a level of guarantee in the reliability of the prediction results provided at the block 226. Further example details of the privacy-preserving framework, preprocessing, capacity processing algorithm, and validation are provided next below.

Security Framework

As previously explained above, a privacy-preserving security framework may be used in order to protect the privacy of the consumers' historical data (e.g., via encryption or other privacy-preserving technique) and to perform the preprocessing operations and machine-learning model on the encrypted historical data (as opposed to performing preprocessing/machine-learning operations on non-encrypted data or cleartext).

According to various embodiments, some privacy-preserving machine-learning techniques and tools may be used to protect the privacy of the historical data (e.g., at the block 208) and to use the protected (e.g., encrypted) historical data to train the machine-learning model (e.g., at the block 224). Example techniques, protocols, and tools that may be used in various embodiments to protect data and to train a machine-learning model or neural network may include, but are not be limited to, multi-party computation (MPC), federated learning, homomorphic encryption, differential privacy, SecureNN, SecureML, MiniONN, TensorFlow, PyTorch, Rosetta, or others or combinations thereof. These tools/protocols may support operations such as matrix multiplication, normalization, etc. that may be performed in the pre-processing of blocks 212-218 or in other blocks of the method 200. Data anonymizing may be used in some embodiments to protect privacy.

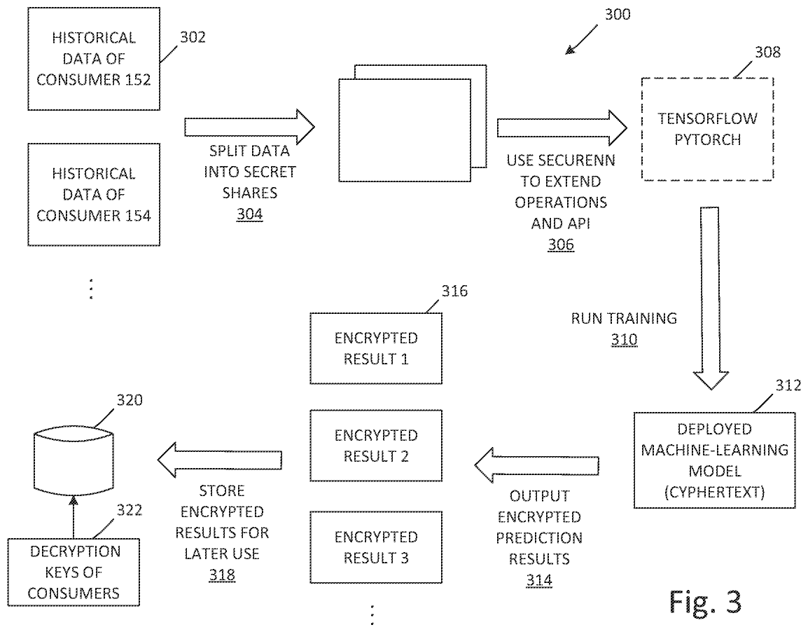

FIG. 3 is a flowchart showing a workflow of an example privacy-preserving framework 300 in accordance with various embodiments. The workflow begins with the historical data 302 (unencrypted) of consumers, such as the consumers 152-156. Then at 304, a collusion-free secret sharing is employed to split the data into shares with masks.

Then, since cryptographic protocols have extended or re-implemented (at 306) the backend kernels of the operations of a machine-learning framework such as TensorFlow/PyTorch 308, then the secure computations (including preprocessing and neural network training at 310) can be carried out using an original application program interface (API).

The training may be run on a deployed machine-learning model 312 using the cyphertext of the historical data, so as to perform predictions/inferences and to output (at 314) encrypted prediction results 316 or other prediction output(s). The encrypted prediction results 316 are stored (at 318) at a server or other storage location 320 for later use. For example, at the client side, the consumers may use their respective decryption keys 322 to decrypt the encrypted prediction results 316 and to obtain storage resource notifications and recommendations in connection with storage capacity planning, including recommendations and other details for allocation of additional storage capacity.

In some embodiments, the recommendations and other capacity planning details to update/increase the capacity may be provided as part of the encrypted results that are in turn decrypted by the consumers in order to view the cleartext version. In other embodiments, the customer can decrypt the prediction results and then separately request the capacity planning recommendations and other storage allocation details from the provider based on the decrypted prediction results.

Data Preprocessing

As previously explained above with respect to FIG. 2, the data preprocessing at the block 212 may be divided into three operations: filtering outliers at the block 214, filling in missing value(s) at the block 216, and normalizing the data at the block 218.

With respect to outliers at the block 214, outliers may include data records that have been stored with a null value. For instance, a dataset may contain/indicate zero physical capacity or total capacity, which is unrealistic or incorrect. As such, these capacity values should be dropped/removing from the dataset.

Other outliers may be caused by a network partition, broken disks, etc., which may be hard to filter out. Under these circumstances, a moving average technique may be used to decrease the influence of these abnormal data points. An example moving average algorithm is provided below:
Input: Training data, Window size
Output: Smoothed data
1. For i in range (Window size)
2. Training data[i]=mean of Training data[:i]
3. EndFor
4. For j in range (Window size, training data length)
5. Training data[j]={sample[j−1]*(Window size−1)+sample[j]}/Window size
6. EndFor
7. Return Training data (smoothed)

With respect to missing values at the block 216, missing values may be filled into a dataset using linear interpolation, based on an assumption that the dataset has a linear pattern. An example formula for linear interpolation between two known points y0 and y1 may be as follows:

y=y0+(x−x0)*(y1−y0)/(x1−x0)={(y0*(x1−x)+y1*(x−x0)}/(x1−x0)

With respect to normalization at the block 218, a normalization technique using a formula (X-μ)/σ may be used, wherein μ is the mean of the training data and σ is the standard deviation of the training data.

Regression for Capacity Forecasting Algorithm and Validation

Studies have shown that storage growth usually has a linear pattern. However, the used capacity for storage clusters typically exhibits a pattern of stepwise (or piecewise) increases or decreases in storage usage over time. As such, linear regression may be insufficient for predicting storage capacity needs.

Accordingly, various embodiments implement a piecewise regression algorithm for predicting future capacity at the block 224 of the method 200 of FIG. 2. The piecewise regression approach not only fits the segments, slopes, and intercepts of the usage patterns, but is also able to fit sudden increases in the usage.

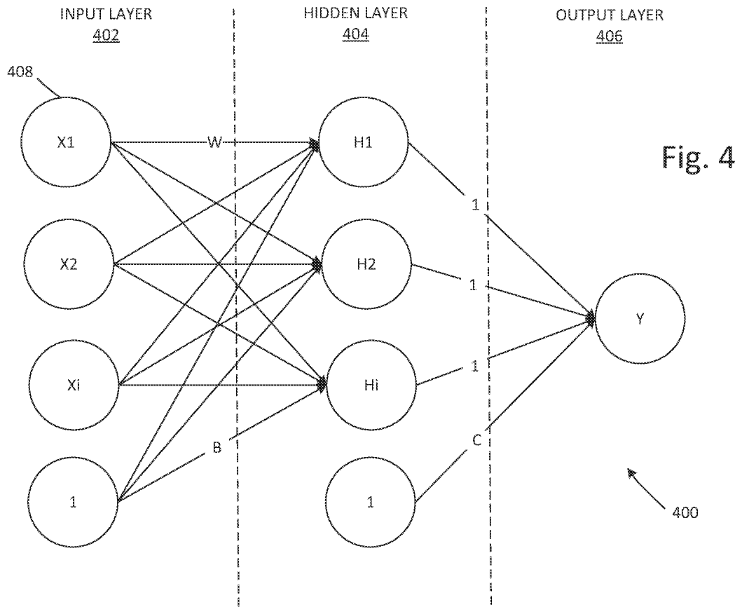

FIG. 4 shows an example regression approach for the capacity forecasting method 200 of FIG. 2, and more specifically, an example 3-layer neural network 400 that implements the piecewise regression approach at the block 224 of the method 200. The layers of the neural network 400 include an input layer 400, a hidden layer 404, and an output layer 406. The input layer 400 receives the data, the hidden layer 404 (e.g., training model) performs the computations, and the output layer 406 produces a prediction result from the input data.

The nodes 408 in the input layer 402 represent multiple features or variables that have a correlation with the used capacity, such as number of virtual machines, number of hosts, number of performance issues, etc. The weights (W) and intercepts for the features are initialized and then optimized through training.

The input layer 402 may be activated, for example, by a rectified linear unit (ReLU) function y=max (0, x) or an error function such as below:

$$\frac{d}{dz} erf ( z ) = \frac{2}{\sqrt{π}} {e}^{- \text{?}}$$

$$\text{?} \text{indicates text missing or illegible when filed}$$

The error function could outperform the ReLU function since the error function adds non-linearity to the model and can fit steeper increases between segments. Moreover, a mean-squared error with L1 regularization and an Adams optimizer may be used for the hidden layer 404.

According to various embodiments, the capacity prediction algorithm may use validation techniques to evaluate the accuracy of the prediction result. One example validation technique is a goodness of fit R² score, wherein R² is a measure of the goodness of fit of the model. The goodness of fit R² score may be defined by the following example formula:

$${R}^{2} ( y , \hat{y} ) = 1 - \frac{{\sum }_{i = 0}^{{n}_{\text{?}} - 1} {( {y}_{i} - {\hat{y}}_{i} )}^{2}}{{\sum }_{i = 0}^{{n}_{\text{?}} - 1} {( {y}_{i} - \tilde{y} )}^{2}}$$

$$\text{?} \text{indicates text missing or illegible when filed}$$

A goodness of fit R² score close to 1 may indicate a good fitting of the model.

Another example validation technique is the use of a prediction error. The prediction error may be defined as |y_true−y_pred|, where y_true and y_pred are the percentages of used capacity with respect to the total capacity. A storage forecasting model (machine-learning model) with a prediction error of less than or equal to 5%, for example, may be considered to be a valid prediction model.

Computing Device

The above examples can be implemented by hardware (including hardware logic circuitry), software or firmware or a combination thereof. The above examples may be implemented by any suitable computing device, computer system, etc. The computing device may include processor(s), memory unit(s) and physical NIC(s) that may communicate with each other via a communication bus, etc. The computing device may include a non-transitory computer-readable medium having stored thereon instructions or program code that, in response to execution by the processor, cause the processor to perform processes described herein with reference to FIGS. 1A to 4.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term “processor” is to be interpreted broadly to include a processing unit, ASIC, logic unit, or programmable gate array etc.

Although examples of the present disclosure refer to “virtual machines,” it should be understood that a virtual machine running within a host is merely one example of a “virtualized computing instance” or “workload.” A virtualized computing instance may represent an addressable data compute node or isolated user space instance. In practice, any suitable technology may be used to provide isolated user space instances, not just hardware virtualization. Other virtualized computing instances may include containers (e.g., running on top of a host operating system without the need for a hypervisor or separate operating system; or implemented as an operating system level virtualization), virtual private servers, client computers, etc. The virtual machines may also be complete computation environments, containing virtual equivalents of the hardware and system software components of a physical computing system. Moreover, some embodiments may be implemented in other types of computing environments (which may not necessarily involve distributed storage), wherein it would be beneficial to more efficiently and accurately perform capacity forecasting for storage resources and/or other computing resources.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood that each function and/or operation within such block diagrams, flowcharts, or examples can be implemented, individually and/or collectively, by a wide range of hardware, software, firmware, or any combination thereof.

Some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware are possible in light of this disclosure.

Software and/or other computer-readable instruction to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

The drawings are only illustrations of an example, wherein the units or procedure shown in the drawings are not necessarily essential for implementing the present disclosure. The units in the device in the examples can be arranged in the device in the examples as described or can be alternatively located in one or more devices different from that in the examples. The units in the examples described can be combined into one module or further divided into a plurality of sub-units.

We claim:

1. A method to perform capacity forecasting for a resource in a virtualized computing environment, the method comprising:
receiving historical data representative of usage of the resource, wherein the historical data is in a privacy-preserving format;
performing preprocessing on the historical data, including filtering outliers, filling in missing values, and normalizing;
generating a prediction output by using a machine-learning model to compute the prediction output from the preprocessed historical data; and
based on the prediction output, providing a recommendation to update the capacity of the resource.

2. The method of claim 1, wherein the resource is a distributed storage system in the virtualized computing environment.

3. The method of claim 1, wherein the privacy-preserving format of the historical data is an encrypted format of the historical data, and wherein machine-learning model operates on the encrypted format of the historical data.

4. The method of claim 1, further comprising:
determining whether an amount of the historical data meets a threshold;
rejecting the historical data, in response to the amount of historical data failing to meet the threshold; and
entering a waiting period until the amount of the historical data meets the threshold.

5. The method of claim 1, further comprising performing a validation technique to determine accuracy of the prediction output.

6. The method of claim 5, wherein performing the validation technique comprises computing a score that is representative of a goodness fit of the machine-learning model.

7. The method of claim 5, wherein performing the validation technique comprises computing a prediction error.

8. The method of claim 1, wherein:
filtering the outliers includes removing first values from any of the historical data that has a null value, and smoothing second values from the historical data using a moving average technique to reduce an influence of the second values,
filling in the missing values includes interpolating the missing values from two known values in the historical data, and
normalizing includes normalizing the historical data based on a mean of the historical data and a standard deviation of the historical data.

9. The method of claim 1, wherein using the machine-learning model to compute the prediction output includes using the machine-learning model to perform a piecewise regression computation on the historical data.

10. The method of claim 1, further comprising:
determining whether the historical data indicates that usage of the resource corresponds to an increasing trend, wherein using the machine-learning model to compute the prediction output is performed only in response to the increasing trend being indicated by the historical data.

11. A non-transitory computer-readable medium having instructions stored thereon, which in response to execution by one or more processors, cause the one or more processors to perform or control performance of a method to forecast capacity for a resource in a virtualized computing environment, wherein the method comprises:
receiving historical data representative of usage of the resource, wherein the historical data is in a privacy-preserving format;
performing preprocessing on the historical data;
inputting the preprocessed historical data into a machine-learning model, wherein the machine-learning model applies a piecewise regression to the historical data to generate a prediction output;
based on the prediction output, determining whether to increase the capacity of the resource; and
providing a recommendation to increase the capacity in response to the determination.

12. The non-transitory computer-readable medium of claim 11, wherein the machine-learning model applies the piecewise regression to an encrypted format of the historical data.

13. The non-transitory computer-readable medium of claim 11, wherein the resource is a distributed storage system in the virtualized computing environment.

14. The non-transitory computer-readable medium of claim 11, wherein preprocessing the historical data includes:
filtering outliers from the historical data by removing first values from the historical data that have a null value, and smoothing second values from the historical data using a moving average technique to reduce an influence of the second values;
filling in missing values in the historical data by interpolating the missing values from two known values in the historical data; and
normalizing the historical data based on a mean of the historical data and a standard deviation of the historical data.

15. The non-transitory computer-readable medium of claim 11, wherein the method further comprises validating the prediction output using at least one of a score that is representative of a goodness fit of the machine-learning model, or a prediction error.

16. A system to forecast storage capacity in a virtualized computing environment, the system comprising:
one or more processors; and
one or more non-transitory computer-readable media coupled to the one or more processors, and having instructions stored thereon, which in response to execution by the one or more processors, cause the one or more processors to perform or control performance of operations that include:
loading historical data representative of usage of the storage capacity;
transforming the historical data into a privacy-preserving format;
preprocessing the historical data;
operating a machine-learning model on the preprocessed data to generate a prediction output indicative of whether to increase the storage capacity, wherein the machine-learning model applies a piecewise regression to the historical data to conform the machine-learning model to non-linear steps in a usage pattern of the storage capacity; and
based on the prediction output, generating a recommendation to increase the storage capacity.

17. The system of claim 16, wherein transforming the historical data into the privacy-preserving format includes encrypting the historical data.

18. The system of claim 16, wherein preprocessing the historical data include:
filtering outlier first values from the historical data, and smoothing second values from the historical data using a moving average technique;
filling in missing values in the historical data by interpolating the missing values; and
normalizing the historical data based on a mean of the historical data and a standard deviation of the historical data.

19. The system of claim 16, wherein the operations further include performing a validation to determine accuracy of the prediction output.

20. The system of claim 16, wherein the operations further include:
determining whether the loaded historical data meets a threshold amount of historical data;
rejecting the loaded historical data, in response to its failure to meet the threshold; and
entering a waiting period until an amount of the loaded historical data meets the threshold, and then subsequently transforming the historical data to the privacy-preserving format.
